(19) United States
(12) Patent Application Publication
(10) Pub. No.: US 2010/0330298 A1
(43) Pub. Date: Dec. 30, 2010

(54) Fabrication Of Ferroelectric Ceramic Films Using Rapid Thermal Processing With Ultra-Violet Rays

(75) Inventors: Chong Yun Kang, Seoul (KR); Kwang Hwan Cho, Gimpo-si (KR); Seok-Jin Yoon, Seoul (KR); Min Gyu Kang, Incheon (KR)

Correspondence Address: JONES DAY, 222 EAST 41ST ST, NEW YORK, NY, 10017, US

(73) Assignee: Korea Institute of Science and Technology

(21) Appl. No.: 12/495,636

(22) Filed: Jun. 30, 2009

(51) Int. Cl. B05D 3/06; B05C 11/00

(52) U.S. Cl. 427/558; 118/666

(57) ABSTRACT

A method for fabricating a ferroelectric ceramic film. The method includes coating a gel film on a substrate. The gel film has at least one ferroelectric material and at least one ultra-violet (UV) sensitive material. The method further includes simultaneously heating the gel film and irradiating a UV ray onto the gel film transforming the gel film into an amorphous ferroelectric film made of the at least one ferroelectric material. The above heating may be performed by using a rapid thermal processing technique.

### TECHNICAL FIELD

The present disclosure relates to ferroelectric ceramic films, and more particularly to the fabrication of ferroelectric ceramic films using rapid thermal processing (RTP) with ultra-violet (UV) rays.

### BACKGROUND

Structures made of a ferroelectric material(s) (e.g., a ferroelectric ceramic film) may be used in the manufacturing of a variety of electric devices. For example, ferroelectric materials may be used for manufacturing capacitors, resonators, phase shifters, frequency filters, voltage dividers, or voltage oscillators of integrated circuits used in radio frequency (RF) communication. In some instances, electrical components made of ferroelectric ceramic film(s) go through various high-temperature heat treatment processes during manufacturing processes.

### SUMMARY

In one embodiment, it is recognized that heat treatment processes of electrical components made of ferroelectric ceramic films at high temperatures may degrade and/or damage other non-ferroelectric electrical components located near the ferroelectric ceramic film(s). These effects may severely limit the applicability of the ferroelectric ceramic films in manufacturing of integrated circuits. In one embodiment a method is provided for fabricating a ferroelectric ceramic film. The method includes coating a gel film on a substrate. The gel film has at least one ferroelectric material and at least one ultra-violet (UV) sensitive material. The method further includes simultaneously heating the gel film and irradiating a UV ray onto the gel film transforming the gel film into an amorphous ferroelectric film made of the at least one ferroelectric material. The above heating may be performed using a rapid thermal processing (RTP) technique.

The Summary is provided to introduce a selection of concepts in a simplified form that are further described below in the Detailed Description. This Summary is not intended to identify key or essential features of the claimed subject matter, nor is it intended to be used in determining the scope of the claimed subject matter.

### BRIEF DESCRIPTION OF THE DRAWINGS

FIG. 1 shows a schematic diagram of an illustrative embodiment of a ceramic film fabrication apparatus.

FIG. 2 shows a detailed schematic diagram of a coating unit in FIG. 1.

FIG. 3 shows a detailed schematic diagram of a heating unit in FIG. 1.

FIG. 4 shows a flow diagram of an illustrative embodiment of a method for fabricating a ferroelectric ceramic film.

FIGS. 5A-5C are a series of diagrams for explaining some of the blocks illustrated in FIG. 4.

FIG. 6 shows a graph showing an illustrative timeline for the heating operations in block 420 of FIG. 4.

FIG. 7 shows a Fourier transform infra-red spectroscopy (FTIRS) graph of an amorphous ferroelectric ceramic film in accordance with an illustrative embodiment.

FIG. 8 shows an X-ray diffractometer (XRD) pattern graph of a ferroelectric ceramic film in accordance with an illustrative embodiment.

FIG. 9 shows atomic force microscope (AFM) pictures of a ferroelectric ceramic film in accordance with an illustrative embodiment.

### DETAILED DESCRIPTION

A detailed description is provided below with reference to the accompanying drawings. One of ordinary skill in the art may realize that the following description is illustrative only and is not in any way limiting. Other embodiments of the present invention may be readily apparent to those having ordinary skill in the art in view of the present disclosure.

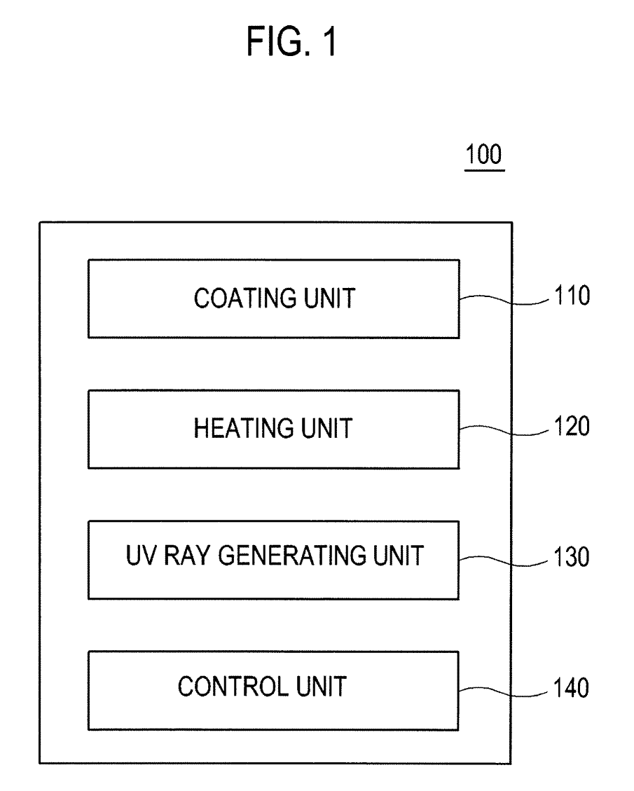

FIG. 1 shows a schematic diagram of an illustrative embodiment of a ceramic film fabrication apparatus. Referring to FIG. 1, a ceramic film fabrication apparatus 100 may include a coating unit 110. Coating unit 110 may include in some embodiments a gel film having at least one ferroelectric material coating a substrate (not shown). A heating unit 120 may be configured to heat the coated gel film at a prescribed temperature. An ultra-violet (UV) ray generating unit 130 may be configured to generate and irradiate a UV ray of a prescribed wavelength to the gel film, and a control unit 140 may be configured to control the overall operation of ceramic film fabrication apparatus 100.

As used herein, ferroelectric materials refer to materials that exhibit an electric dipole moment even in the absence of an electric field. Examples of such ferroelectric materials include, but are not limited to, perovskites (e.g., BaTiO₃, CaTiO₃, KNbO₃, or SrTiO₃), oxides (e.g., LiNbO₃, or LiTaO₃), complex oxides with a tungsten bronze structure (e.g., SrₓBa₁₋ₓNb₂O₆(SBN)), non-oxide sulfur iodides (e.g., SbSI, SbSeI, or BiSI), bismuth germanium compounds (e.g., Bi₁₂GeO₂₀, or Bi₁₂SiO₂₀), and (PLZT) ceramics (e.g., PbLaZrTi). Ferroelectric materials in some embodiments may be made of ferroelectric particles having the size of about a few to a few tens of nanometers in at least one of three spatial dimensions. Further, as used herein, a gel in some embodiment refers to a material consisting essentially of two phases, a solid phase and a liquid phase. A gel film in some embodiments refers to a film made of materials such as bi-phase materials.

Coating unit 110 may be configured to apply a solution that includes a ferroelectric material(s) onto the substrate. The applied solution is then dried to form a gel film. The substrate may be made of one or more materials (e.g., metals, semiconductors, ceramics, or polymers) that are resistant to heat (e.g., free of deformation even at high temperatures) and non-reactive to UV rays. In one embodiment, the solution may include a UV sensitive material(s), so as to facilitate its absorption of the UV ray generated by UV ray generating unit 130. In one example, the UV sensitive material may be a material of an acetyl-acetonate group, such as metal acetyl-acetonate or acetyl-acetone.

In some embodiments, coating unit 110 may be configured to heat the applied solution at a first prescribed temperature, so as to dry and transform the applied solution into a gel film. By way of a non-limiting example, the first prescribed temperature may be in the range of from about 100° C. to about 150° C.

Heating unit 120 may be configured to heat the gel film at a second prescribed temperature to transform the gel film into an amorphous ferroelectric structure (e.g., an amorphous ferroelectric ceramic film). By way of a non-limiting example, the second prescribed temperature may be in the range of from about 350° C. to about 400° C. Heating unit 120 may include a component(s) configured to perform one of various known heating techniques in the art to suitably transform the gel film disposed on the substrate into an amorphous ferroelectric ceramic film. Examples of such heating techniques include, but are not limited to, rapid thermal processing (RTP) (or rapid thermal annealing (RTA)) or laser annealing (LA).

In some embodiments, heating unit 120 may be configured to further heat the amorphous ferroelectric ceramic film formed on the substrate at a third prescribed temperature, so as to transform or crystallize the amorphous ferroelectric ceramic film into a crystalline ferroelectric structure (e.g., a crystalline ferroelectric ceramic film). By way of a non-limiting example, the third prescribed temperature may be in the range of from about 350° C. to about 400° C. Heating unit 120 may include a component(s) configured to perform one of various known heating techniques in the art to effectively transform the amorphous ferroelectric ceramic film formed on the substrate into the crystalline ferroelectric ceramic film. Examples of such heating techniques include, but are not limited to, furnace annealing (FA).

UV ray generating unit 130 may be configured to generate and irradiate a UV ray to the gel film on the substrate. In one embodiment, UV ray generating unit 130 may include an excimer UV lamp, which may generate high-power UV rays. The UV rays may be of a prescribed wavelength in the range of from about 200 nm to about 300 nm. The concrete configurations necessary for generating and irradiating a UV ray is well known in the art and can be implemented without the need for further explanation herein.

Control unit 140 may be configured to operatively control UV ray generating unit 140 to irradiate a UV ray onto the coated gel film, while the coated gel film is being heated by heating unit 120. In one embodiment, control unit 140 may include a microprocessor unit or the like to operatively control coating unit 110, heating unit 120, and UV ray generating unit 130.

Ferroelectric materials (and ceramic films made therefrom) in an amorphous state exhibit low ferroelectricity and high dielectric loss, which makes them unsuitable to be used as building blocks for electric components of an integrated circuit. Thus, they need to be crystallized to improve their electrical characteristics. Amorphous ferroelectric materials, however, crystallizes at a high temperature, usually well above 600° C. Ceramic film fabrication apparatus 100 according to one embodiment may be configured to irradiate UV rays when heating a gel film to transform it into an amorphous ferroelectric ceramic film. The photochemical energy provided by the UV rays, combined with the heat energy, effectively breaks the chemical bonds between the metal oxide molecules (i.e., ferroelectric elements) and ligands in the amorphous ferroelectric ceramic film (e.g., bonds between metal oxide molecules and carbon atoms, bonds between metal oxide molecules, carbon atoms and oxygen atoms, or bonds between metal oxide molecules, carbon atoms and hydrogen atoms). This enables ceramic film fabrication apparatus 100 to heat the amorphous ferroelectric ceramic film at a relatively lower temperature (e.g., 350° C. to about 400° C.) in crystallizing the amorphous ferroelectric ceramic film into a crystalline ferroelectric ceramic film.

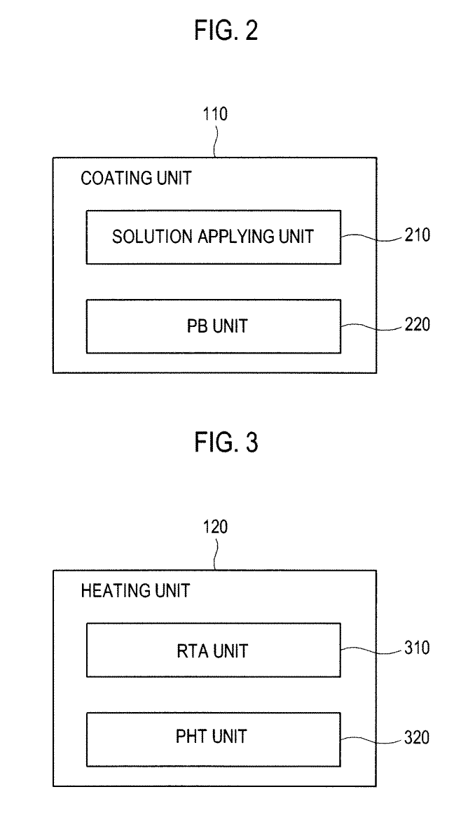

FIG. 2 shows a detailed schematic diagram of a coating unit in FIG. 1. Referring to FIG. 2, coating unit 110 may include a solution applying unit 210 configured to apply a solution including a ferroelectric material(s) onto a substrate and a pre-baking (PB) unit 220 configured to heat the applied solution, so as to dry and transform the applied solution into a gel film.

Solution applying unit 210 may be configured to perform one or more of various known techniques known in the art to apply the solution onto the substrate. Examples of such techniques include, but are not limited to, spraying, dipping, or spinning. In the spraying example, solution applying unit 210 may include a spraying unit configured to aerobically spray a solution including a ferroelectric material(s) toward a substrate. In the dipping example, solution applying unit 210 may include a container configured to retain a solution including a ferroelectric material(s) and receive the substrate therein, and optionally, a transport unit configured to move the container to a desired location. In the spinning example, particle supply unit 110 may include a spinning unit to spin-coat a solution containing a ferroelectric material(s) onto a substrate, thereby forming a uniform thin film of the solution onto the substrate. The above solution may include substance(s) (e.g., polymers) for increasing viscosity. The concrete configurations necessary for the spraying, dipping, or spinning techniques are well known in the art and can be implemented without the need of further explanation herein.

PB unit 220 may be configured to perform pre-bake techniques to dry and transform the applied solution into a gel film. In one embodiment, PB unit 220 may include a hot plate. In another embodiment, PB unit 220 may include a pre-bake oven. The concrete configurations of the hot plate and the pre-bake oven are well known in the art and can be implemented without the need of further explanation herein.

FIG. 3 shows a detailed schematic diagram of a heating unit in FIG. 1. Referring to FIG. 3, heating unit 120 may include a rapid thermal annealing unit 310 and a post-heat treatment (PHT) unit 320.

RTA unit 310 may be configured to rapidly heat a gel film formed on a substrate to transform it into an amorphous ferroelectric ceramic film by using a rapid thermal processing technique. In one embodiment, RTA unit 310 may include a housing, a lamp (e.g., a halogen lamp) disposed therein configured to produce heat, and a control unit configured to control the lamp.

PHT unit 320 may be configured to heat the amorphous ferroelectric ceramic film formed on the substrate to transform or crystallize it into a crystalline ferroelectric ceramic film. In one embodiment, PHT unit 320 may include a tube furnace configured to perform furnace annealing on the amorphous ferroelectric ceramic film. The concrete configurations of the tube furnace are well known in the art and can be implemented without the need of further explanation herein.

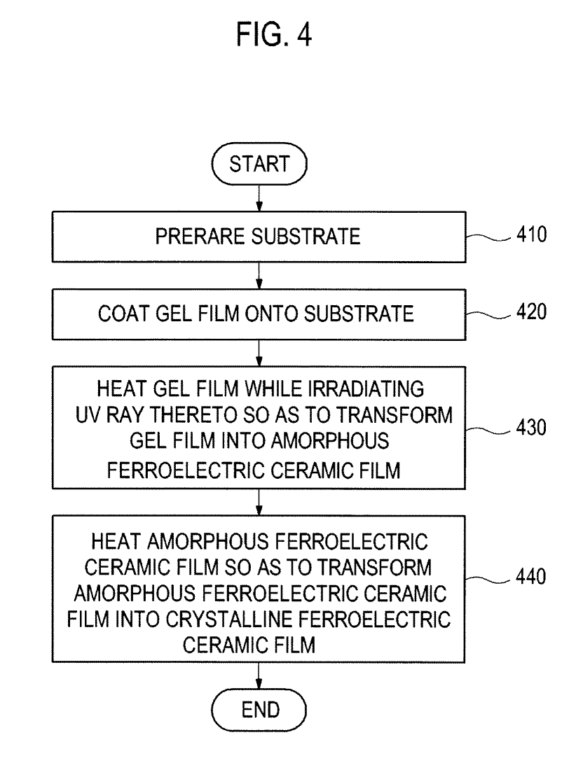

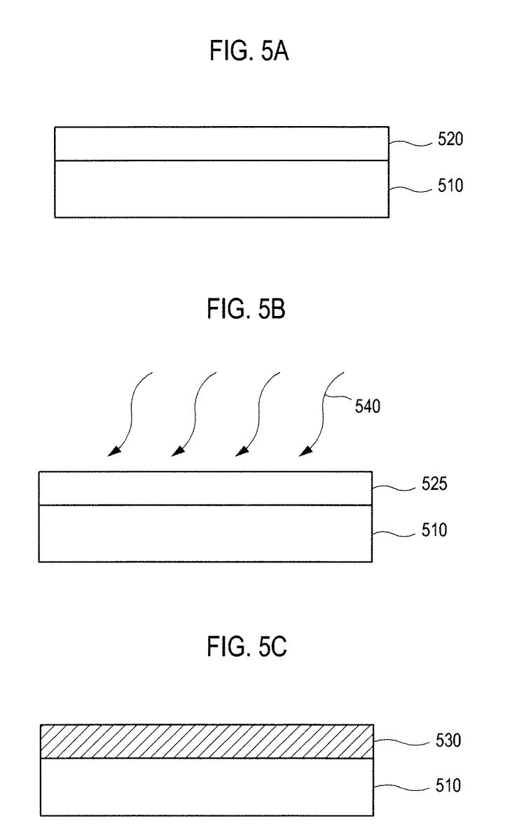

FIG. 4 shows a flow diagram of an illustrative embodiment of a method for fabricating a ferroelectric ceramic film. FIGS. 5A-5C are a series of diagrams for explaining some of the blocks illustrated in FIG. 4. The method illustrated in FIG. 4 may be performed by a fabrication apparatus similar to the one illustrated in FIGS. 1-3. The control unit of the fabrication apparatus may operatively control the processes performed by other units thereof. Referring to FIG. 4, in block 410, a substrate may be prepared. In block 420, a gel film including a ferroelectric material(s) may be coated onto the substrate. FIG. 5A shows a substrate 510 coated with a gel film 520. In one embodiment, a solution including a ferroelectric material(s) may be applied onto substrate 510 by a solution applying unit of the fabrication apparatus, and the applied solution may be heated to a first prescribed temperature for a first prescribed time by a PB unit of the fabrication apparatus, so as to dry and transform the applied solution into a gel film.

The solution may be prepared by dispersing the ferroelectric material(s) into a solvent. For example, water (e.g., de-ionized water) or organic solvents (e.g., alkane or toluene) may be used as the solvent. In one embodiment, the solution may be prepared by stirring the solution at a temperature in the range from about 100° C. to about 150° C. In one embodiment, the solution may further include a UV sensitive material(s), which may allow gel film 520 formed from the applied solution to better absorb the energy of UV rays 540 irradiated thereto. The prepared solution may be applied onto substrate 510 by using one of a variety of well-known techniques known in the art (e.g., spraying, dipping, or spin coating). The subsequent heating of the applied solution at the first prescribed temperature for the first prescribed time will dry the applied solution by removing the solvent from the substrate. By way of a non-limiting example, the first prescribed temperature may be in the range from about 100° C. to about 150° C., and the first prescribed time may be in the range from about 5 minutes to about 10 minutes.

In block 430, as shown in FIG. 5B, gel film 520 on substrate 510 is heated at a second prescribed temperature for a second prescribed time period by a RTA unit of the fabrication apparatus, while UV rays 540 are irradiated thereto by a UV ray generating unit of the fabrication apparatus, so as to transform gel film 520 into an amorphous ferroelectric ceramic film 525. By way of a non-limiting example, the second prescribed temperature may be in the range from about 350° C. to about 400° C., and the second time period may be in the range from about 5 minutes to about 10 minutes. During the above process, the organic materials contained in gel film 520 are removed by breaking the chemical bonds between the metal oxide molecules and the ligands in the gel film.

In some embodiments, gel film 520 may be heated prior to and/or after irradiating UV rays 540 to gel film 520. In one embodiment, prior to irradiating UV rays 10 to gel film 520, gel film 520 may be heated at the second prescribed temperature for a third prescribed time period. By way of a non-limiting example, the third prescribed time period may be in the range from about 3 minutes to about 5 minutes. The heat energy provided to gel film 520 during the above process lowers the bonding energy between the elements included in gel film 520, and thus, facilitates the breaking of the chemical bonds in gel film 520 when UV rays 540 are irradiated (i.e., lowers the crystallization energy required to form a crystalline ferroelectric ceramic film).

In another embodiment, after terminating the irradiation of UV rays 540 to gel film 520, gel film 520 may be further heated at the second prescribed temperature for a fourth prescribed time period. By way of a non-limiting example, the fourth time period may be in the range from about 5 minutes to about 10 minutes. Amorphous ferroelectric ceramic film 525 produced by the combined heating and irradiation process includes pores in places previously occupied by the removed impurities. These pores may adversely affect the electrical characteristics of amorphous ferroelectric ceramic film 525 and the final product. The above heating process agglomerates the elements contained in amorphous ferroelectric ceramic film 525, and thus, effectively removes at least some of the pores therein.

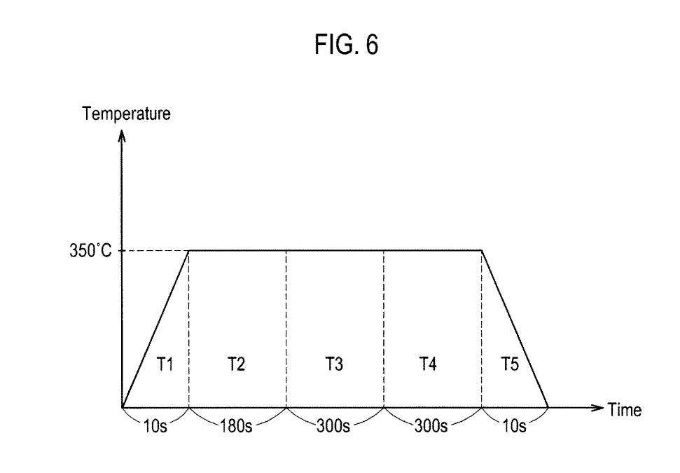

FIG. 6 shows a graph showing an illustrative timeline for the heating operations in block 420 of FIG. 4. Referring to FIG. 6, the timeline of block 420 may be divided into five intervals (i.e., intervals T1-T5). In interval T1, the RTA unit of the ceramic film fabrication device raises the temperature from an initial temperature (e.g., 0° C.) to the second prescribed temperature at a prescribed temperature increase rate. For example, as shown in FIG. 6, the temperature may be raised to about 350° C. by raising the temperature at a rate of about 35° C./sec for about 10 seconds. In intervals T2-T4, the RTA unit maintains the temperature to the second prescribed temperature for about 180 seconds, 300 seconds, and 300 seconds, respectively. Gel film 520 is irradiated with UV rays 540 during interval T3, and not during interval T2 and T4. In interval T5, the temperature is decreased back to the initial temperature at a prescribed temperature decrease rate. For example, as shown in FIG. 6, in some embodiments the temperature may be decreased back to 0° C. by decreasing the temperature at a rate about 35° C./sec for about 10 seconds.

Referring back to FIG. 4, in block 440, amorphous ferroelectric ceramic film 525 on substrate 510 may be heated by a PHT unit of the ceramic film fabrication apparatus at a third prescribed temperature for a fifth time period, so as to transform amorphous ferroelectric ceramic film 525 into a crystalline ferroelectric ceramic film 530, as shown in FIG. 5C. By way of a non-limiting example, the third prescribed temperature may be in the range from about 350° C. to about 400° C., and the fifth time period may be in the range from about 1 hour to about 12 hours.

In one embodiment, amorphous ferroelectric ceramic film 525 may be heated under oxygen, so as to provide oxygen atoms thereto. Amorphous ferroelectric ceramic film 525 produced in block 430 and crystalline ferroelectric ceramic film 530 produced therefrom may have an oxygen deficient region(s). This leads to degradation of electrical characteristics (e.g., high dielectric loss). By providing oxygen atoms during the heating process, the total area and/or number of oxygen deficient region(s) in crystalline ferroelectric ceramic film 530 may be reduced. Crystalline ferroelectric ceramic film 530 may have smaller oxygen deficient region(s) and thus may have better electrical characteristics (e.g., lower dielectric loss) compared to the ones heated without oxygen.

The outlined steps and operations in FIG. 4 are only provided as examples, and some of the steps and operations may be optional, combined into fewer steps and operations, or expanded into additional steps and operations without departing from the essence of the disclosed embodiments. For example, in some embodiments, the processes outlined in blocks 420 and 430 may be repeated prior to performing the processes outlined in block 440, so as to laminate a desired number of amorphous ferroelectric ceramic films on a substrate prior to forming a final crystalline ferroelectric ceramic film.

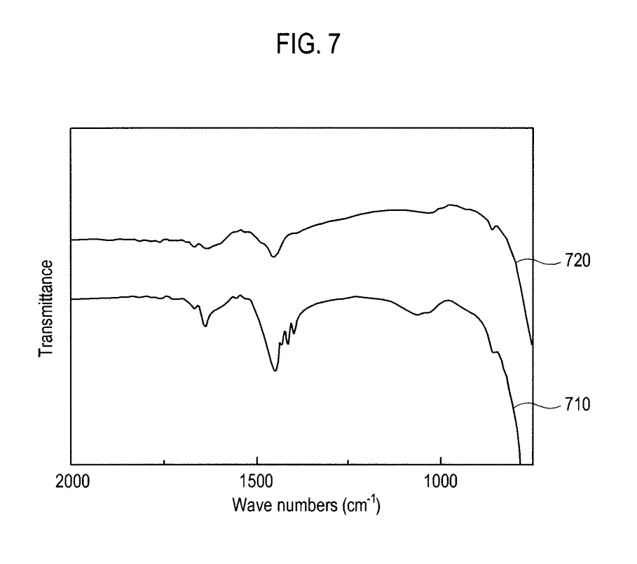

FIG. 7 shows a Fourier transform infra-red spectroscopy (FTIRS) graph of an amorphous ferroelectric ceramic film in accordance with an illustrative embodiment. Referring to FIG. 7, a solid graph 710 represents the FTIRS graph of an amorphous ferroelectric ceramic film produced without UV ray irradiation, and a dotted graph 720 represents the FTIRS graph of an amorphous ferroelectric ceramic film produced with UV ray irradiation. As shown in FIG. 7, solid graph 710 has higher transmittance compared to dotted graph 720, which implies that the amorphous ferroelectric ceramic film produced without UV ray irradiation has a greater number of chemical bonds between the metal oxide molecules and the ligands (e.g., bonds between metal oxide molecules and carbon atoms, bonds between metal oxide molecules, carbon atoms and oxygen atoms, or bonds between metal oxide molecules, carbon atoms and hydrogen atoms) compared to the amorphous ferroelectric ceramic film produced without UV ray irradiation. Thus, the amorphous ferroelectric ceramic film produced in accordance with the present disclosure may be processed at a much lower temperature in producing a crystalline ferroelectric ceramic film therefrom.

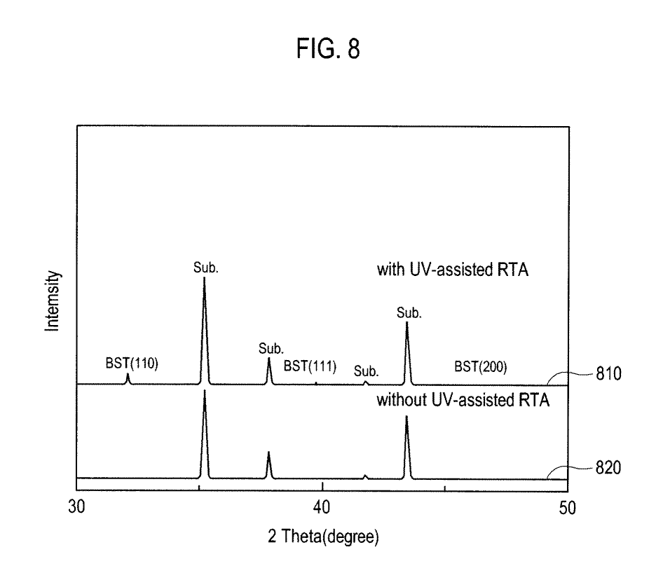

FIG. 8 shows an X-ray diffractometer (XRD) pattern graph of a ferroelectric ceramic film in accordance with an illustrative embodiment. Referring to FIG. 8, a graph 810 represents the XRD pattern graph of a ferroelectric ceramic film produced without UV ray irradiation, and a graph 820 represents the XRD pattern graph of a ferroelectric ceramic film produced with UV ray irradiation. Both ferroelectric ceramic films were heated at the same temperature, i.e., 350° C. As shown in FIG. 8, graph 820 has a greater number of peaks compared to graph 810. This implies that the ferroelectric ceramic film produced with UV ray irradiation was crystallized even when heated at 350° C.

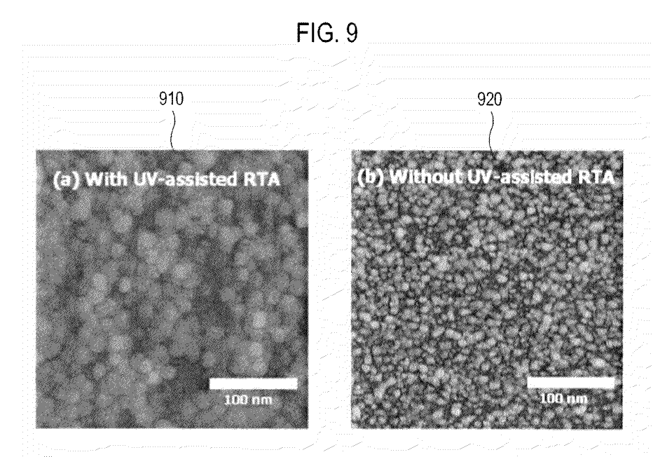

FIG. 9 shows atomic force microscope (AFM) pictures of a ferroelectric ceramic film in accordance with an illustrative embodiment. Referring to FIG. 9, a picture 920 is an AFM picture of a ferroelectric ceramic film produced without UV ray irradiation, and a picture 910 is an AFM picture of a ferroelectric ceramic film produced with UV ray irradiation. As shown in FIG. 9, the ferroelectric ceramic film produced with UV ray irradiation has a relatively larger crystal grain size compared to the ferroelectric ceramic film produced without UV ray irradiation. The dielectric constant and the dielectric loss constant of the ferroelectric ceramic film produced with UV ray irradiation respectively are 183 and 0.05, whereas those of the ferroelectric ceramic film produced without UV ray irradiation respectively are 46 and 0.02. This means that the ferroelectric ceramic film produced with UV ray irradiation has much better electrical characteristics compared to those of the ferroelectric ceramic film produced without UV ray irradiation.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for fabricating a ferroelectric ceramic film, the method comprising:
coating a gel film on a substrate, the gel film comprising at least one ferroelectric material and at least one ultra-violet (UV) sensitive material; and
simultaneously heating the gel film and irradiating a UV ray onto the gel film transforming the gel film into an amorphous ferroelectric ceramic film made of the at least one ferroelectric material,
wherein the heating is performed by using a rapid thermal processing technique.

2. The method of claim 1, wherein the coating a gel film comprises:
applying a solution onto the substrate, the solution including the at least one ferroelectric material and the at least one UV sensitive material; and
heating the solution at a first prescribed temperature for a first prescribed time period transforming the applied solution into the gel film.

3. The method of claim 2, wherein the first prescribed temperature is in the range from about 100° C. to about 150° C. and the first time period is in the range from about 5 minutes to about 10 minutes.

4. The method of claim 1, further comprising heating the gel film after coating the gel film wherein heating the gel film comprises:
heating the gel film at a prescribed temperature for a time period prior to irradiating the UV ray thereto.

5. The method of claim 4, wherein the prescribed temperature is in the range from about 350° C. to about 400° C. and the time period is in the range from about 3 minutes to about 5 minutes.

6. The method of claim 1,
wherein simultaneously heating the gel film and irradiating a UV ray onto the gel film comprises heating the gel film at a temperature in the range from about 350° C. to about 400° C., for a time period from about 5 minutes to about 10 minutes.

7. The method of claim 1, further comprising:
heating the gel film after irradiating the UV ray onto the gel film.

8. The method of claim 7, wherein heating the gel film after irradiating the UV ray comprises heating the gel film at a prescribed temperature in the range from about 350° C. to about 400° C. and a time period in the range from about 5 minutes to about 10 minutes.

9. The method of claim 1, further comprising:
heating the amorphous ferroelectric ceramic film after simultaneously heating the gel film and irradiating a UV ray wherein the amorphous ferroelectric ceramic film is heated at a prescribed temperature for a time period, so as to transform the amorphous ferroelectric ceramic film into a crystalline ferroelectric ceramic film.

10. The method of claim 9, wherein the prescribed temperature is in the range from about 350° C. to about 400° C. and the time period is in the range from about 1 hour to about 12 hours.

11. The method of claim 9, wherein heating the amorphous ferroelectric ceramic film comprises:
heating the amorphous ferroelectric ceramic film with oxygen so as to provide oxygen atoms thereto.

12. The method of claim 1, wherein the at least one UV sensitive material includes at least one material of an acetyl-acetonate group.

13. The method of claim 1, wherein the UV ray is of a wavelength in the range from about 200 nm to about 300 nm.

14. An apparatus for fabricating a ferroelectric ceramic film, the apparatus comprising:
a coating unit configured to coat a gel film onto a substrate, the gel film comprising at least one ferroelectric material and at least one ultra-violet (UV) sensitive material;
a heating unit configured to heat the coated gel film by using a rapid thermal processing technique;
a ultra-violet (UV) ray generating unit configured to generate a UV ray; and
a control unit configured to operatively control the UV ray generating unit to irradiate the UV ray onto the coated gel film, while the coated gel film is being heated by the heating unit.

15. The apparatus of claim 14, wherein the coating unit comprises:
a solution applying unit configured to apply a solution onto the substrate, the solution including the at least one ferroelectric material and the at least one UV sensitive material; and
a pre-bake (PB) unit configured to heat the applied solution at a first prescribed temperature, so as to transform the applied solution into the gel film.

16. The apparatus of claim 14, wherein the heating unit comprises:
a rapid thermal annealing (RTA) unit configured to heat the gel film at a second prescribed temperature while the UV ray is being irradiated thereto, so as to transform the gel film into an amorphous ferroelectric ceramic film made of the at least one ferroelectric material.

17. The apparatus of claim 16, wherein the heating unit further comprises:
a post heat treating (PHT) unit configured to heat the amorphous ferroelectric ceramic film at a third prescribed temperature, so as to transform the amorphous ferroelectric ceramic film into a crystalline ferroelectric ceramic film.

18. The apparatus of claim 14, wherein the at least one UV sensitive material includes at least one material of an acetyl-acetonate group.
